(19) United States
(12) Patent Application Publication
(10) Pub. No.: US 2014/0172608 A1
(43) Pub. Date: Jun. 19, 2014

(54) SYSTEM, METHOD, AND COMPUTER PROGRAM PRODUCT FOR PLACING AN ORDER VIA A SOCIAL COMMUNICATIONS NETWORK

(71) Applicant: SCIENCE MEDIA, LLC, Santa Monica, CA (US)

(72) Inventors: Ryan Sit, San Diego, CA (US); Jonathan Neddenriep, San Diego, CA (US)

(73) Assignee: Science Media, LLC, Santa Monica, CA (US)

(21) Appl. No.: 13/714,182

(22) Filed: Dec. 13, 2012

(51) Int. Cl. G06Q 50/00

(52) U.S. Cl. CPC G06Q 50/01; G06Q 30/0601
USPC 705/26.1

(57) ABSTRACT

Described is a system for placing an order for a product via a communications network. The system receives information regarding a user action in a network-based application, where the user action is related to a product and includes a user ID, which is correlated with further transactional information via an ID sharing application. A message is then sent to the client system, confirming the order. The message can be sent by any form of communication and allow the user to alter order-related information, such as canceling the order, altering a quantity ordered, altering a payment method, and editing delivery information. The information regarding the user action may be pushed from the network-based application to the system or pulled from the network-based application by the system. The system is particularly applicable where the network-based application is a social network and the user action is a social action such as rating, “liking,” and commenting.

### FIELD OF INVENTION

The present invention relates to e-commerce systems, and more particularly, to a system for placing online orders via social communication networks.

### BACKGROUND OF INVENTION

The Internet is a large compilation of computers and computer networks connected by communication links. The World Wide Web is an aspect of the Internet that allows server computers to send multimedia information for display on client computers, which display the information in programs known as “web browsers.” The World Wide Web is now a major source of information for people throughout the world, and is supplanting other forms of media such as print publications, radio, and television. Over the last two decades, the World Wide Web has become a major source of commerce, e-commerce as it has come to be known.

In addition to its uses as an information resource, the Internet allows people to interact socially using tools such as e-mail and instant messaging/text messaging. Web sites dedicated to social interaction have existed for some time, including dating sites such as Match.com and eHarmony, which allow users to seek partners for romantic relationships. More recently, social communication web sites such as MySpace, Facebook, and Twitter have been developed which allow users to present information about themselves and to socially interact in near real-time.

One feature of social communication networks is that they allow users to perform various “social actions.” Examples of social actions include allowing users to rate photos, make comments, “like” items, etc. These actions allow users to interact and give feedback regarding items of other users.

In addition to person-to-person social interaction, social communications networks are also used by business as a means to present an online identity for themselves and to allow consumers to interact with them socially (i.e., making comments regarding, rating, and “liking”/“disliking” products and services). Although social communication networks are robust in terms of features that allow users to interact with others socially, they have limited use as e-commerce forums.

A need currently exists for a system that can take advantage of social actions made by users in a social networking environment in order to facilitate direct e-commerce over social communications networks. The present invention solves this need as described below.

### SUMMARY OF INVENTION

### Brief Description of the Drawings

The objects, features and advantages of the present invention will be apparent from the following detailed descriptions of the various aspects of the invention in conjunction with reference to the following drawings, where:

FIG. 1 is a block diagram depicting the components of a general-purpose data processing system for use with the present invention;

FIG. 2 is an illustration of a computer program product according to the present invention;

FIG. 3 is flow chart depicting acts performed by the present invention;

FIG. 4 is an illustration depicting the interaction of the present invention with other parts of a communications network, particularly in the context of a social network.

### DETAILED DESCRIPTION

The present invention relates to e-commerce systems, and more particularly, to a system for placing online orders via social communication networks. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail first a description of various principal aspects of the present invention is provided. Subsequently, specific details of the present invention are provided to give an understanding of the specific aspects.

(1) Principal Aspects

The present invention has three “principal” aspects. The first is a system for placing an order for a product via a communications network. The communications network comprises a multitude of individual data processing systems. Each individual data processing system is typically a computer system (with one or more processors) operating software or in the form of a “hard-coded” instruction set. This system may be used in conjunction with a wide variety of devices that provide different functionalities, including devices such as desktop/laptop computers, mobile phones, tablet-type computers, among others. The second principal aspect is a method, typically in the form of software, operating over the Internet, and particularly on the World Wide Web. The third principal aspect is a computer program product. The computer program product generally represents computer-readable instructions stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

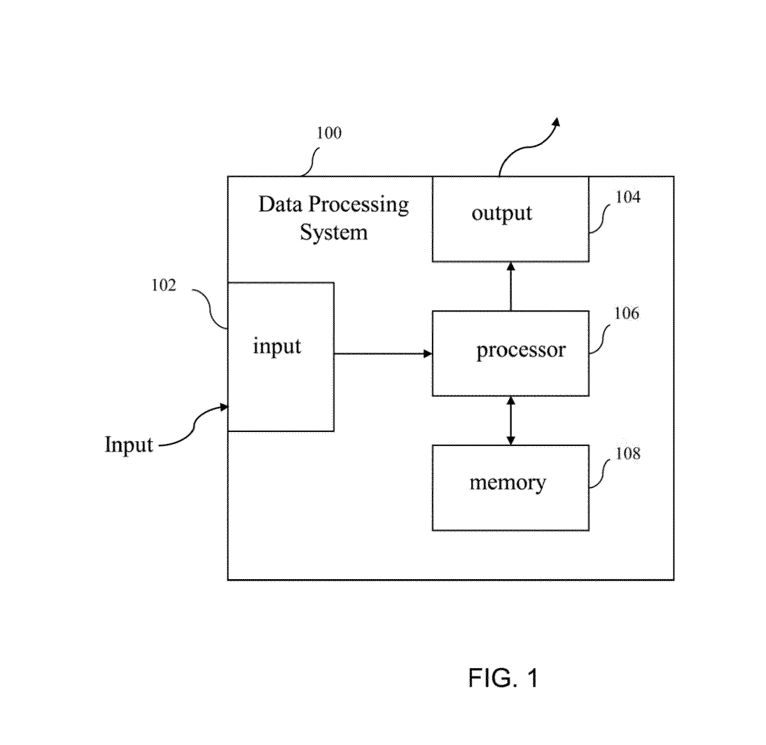

A block diagram depicting the components of a general-purpose data processing system for use in conjunction with the present invention is provided in FIG. 1. This data processing system 100 can represent either a server system or a client system, with both being present as components of the Internet. The system 100 comprises an input 102 for receiving information from other computers on the Internet The input 102 may include multiple “ports.” An output 104 is connected with the processor for sending information to other computers on the Internet. Output may also be provided to other devices or other programs; e.g., to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software that are to be manipulated by commands to the processor 106.

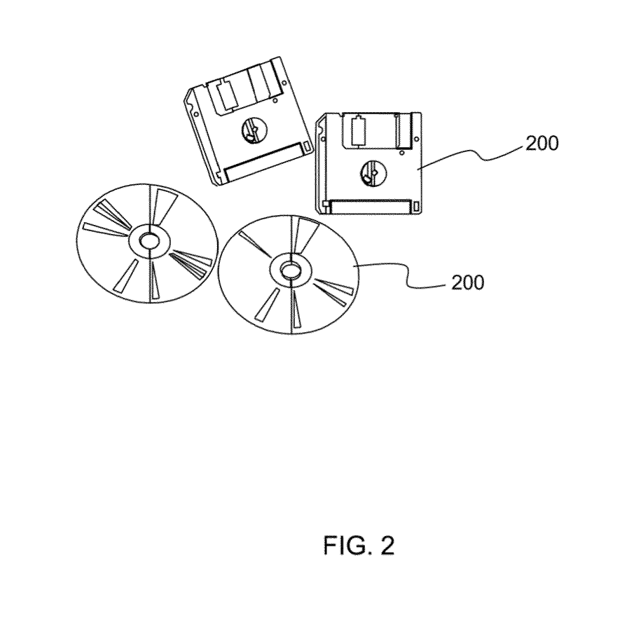

An illustrative diagram of a computer program product embodying the present invention is depicted in FIG. 2. The computer program product 200 is depicted as an optical disk such as a CD or DVD. However, as mentioned previously, the computer program product generally represents computer-readable instruction means stored on any compatible computer-readable medium. The term “instruction means” as used with respect to this invention generally indicates a set of operations to be performed on a computer, and may represent pieces of a whole program or individual separable, software modules. Non-limiting examples of “instruction means” include computer program code (source or object code) and “hard-coded” electronics (i.e., computer operations coded into a computer chip). The “instruction means” may be stored in the memory of a computer or on a computer-readable medium such as a floppy disk, a CD-ROM, or a flash drive.

(2) Specific Details

The present invention comprises software that enables businesses to sell products and services via network-based applications that ordinarily are not designed to directly facilitate e-commerce. Important examples of such network-based applications include social network sites such as Facebook (www.facebook.com) and MySpace (www.myspace.com). On social network sites, users create accounts, which enable them to upload multimedia content for display to other users in the form of web pages. Users interact socially with each other with various social actions, examples of which include:
Commenting—where users type comments or messages to each other;
Liking—where users can indicate simply whether they like or dislike an item on the web page; and
Rating—where users are able to rate items on the web page.

By interacting using social actions, users are able to clearly communicate with each other and to create an enjoyable sense of community.

Businesses often create accounts on social network sites in order to create an online presence and to interact with their customers. Social network sites allow the business's customers to use social actions to indicate product/service preferences. For example, a company could display a picture of a product and invite users to use social actions such as those listed above in order to indicate their approval of the product/service and whether it is something they would like to buy.

One current drawback of social network sites is that they do not lend themselves to direct e-commerce. While social network sites may enable businesses to include links to other web sites where they sell their products, they do not enable direct e-commerce within the social network, sites themselves. The present invention provides a solution to this problem, enabling businesses to use the social actions available on social network sites to facilitate direct e-commerce from within the social network sites (i.e., without requiring the user to navigate away from the social network site).

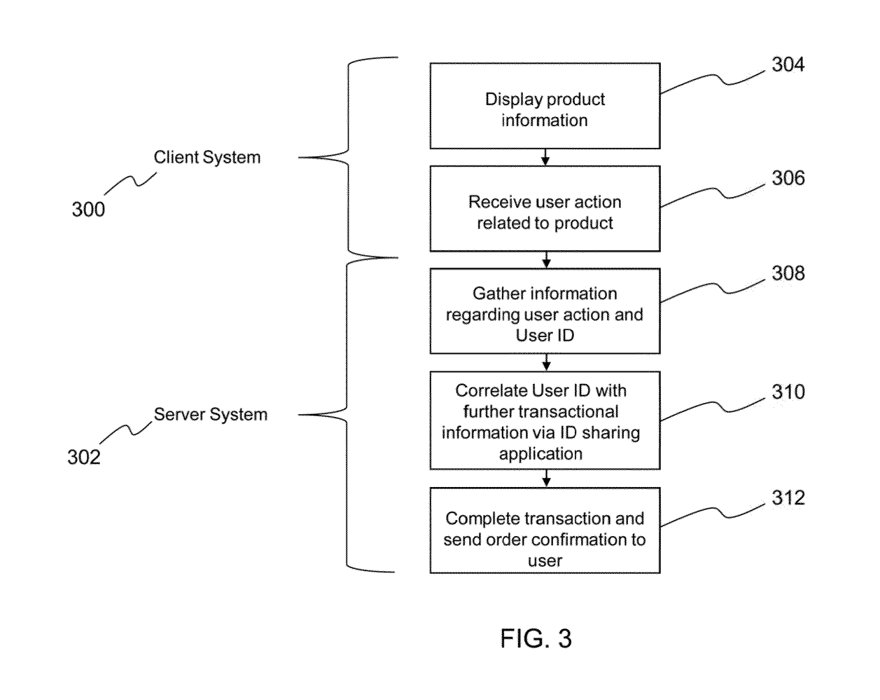

The present invention is generally in the form of computer software operating on the Internet, which collects information from a social network site. The acts performed by the software are depicted in FIG. 3, and are described below.

It is assumed that the business/seller is operating an account on a social network site such as Facebook. Typically, users interact with the social network site through web browsers located on their computers, which in this case are considered the client system 300. The software of the present invention generally operates on a separate server system 302, although functions of the present invention can be performed by the client system 300 or the social network site (not shown).

When a user uses the client system 300 to access information from the business/seller on the social network site, information regarding products and/or services from the business/seller is displayed 304. In order to facilitate e-commerce on the social network site, software on the server system 302 monitors social actions taken by users. For example, to facilitate a transaction, a business/seller places a product for display on their page on a social network site, and permits customers to indicate whether they “like” the product. Text or another such indicator is placed proximate the image of the product, explaining to customers that if they choose to take an action of “liking” the product, they are choosing to purchase the product. The client system 300 receives a social action by the user 306, which is reflected on the social network site.

Software on the server system 302 gathers information regarding the user action along with the user identification (user ID) 308. This information can be “pulled” from the social network site by software on the server system 302, or in some cases, software on the social network site could “push” this information to the server system 302.

Once the user action/user ID information has been gathered 308 from the social network site, the server system 302 uses the user ID to obtain additional transactional information via an ID sharing application 310. ID sharing applications are applications, such as digital wallets/e-wallets, that act as repositories for additional information to be stored by a user in a manner that can be accessed by other web applications upon approval of the user. This additional transactional information includes information needed to complete the transaction, such as physical and billing address information, e-mail address information, and credit card/payment information. ID sharing applications such as Facebook Connect, Google Wallet, and Windows Live ID can be used for this purpose.

After correlating the user ID with the further transactional information via the ID sharing application 310, the server system 302 completes the transaction and sends an order confirmation to the user 312. Typically, the order confirmation is in the form of an e-mail message, but may take any other communicative form, non-limiting examples including phone calls, faxes, and text messages. The message may provide information that allows the user to change various aspects of the purchase, such as quantity ordered, payment method, and delivery information for the order. The completion of the transaction may be instantaneous or it may be delayed in order to provide the user with a time period in which to respond to the message. The delay may be a short period such as 15 to 30 minutes, or it may be long such as a 12 to 24 hour period. The delay can be tailored the needs of the system and the communications methods used.

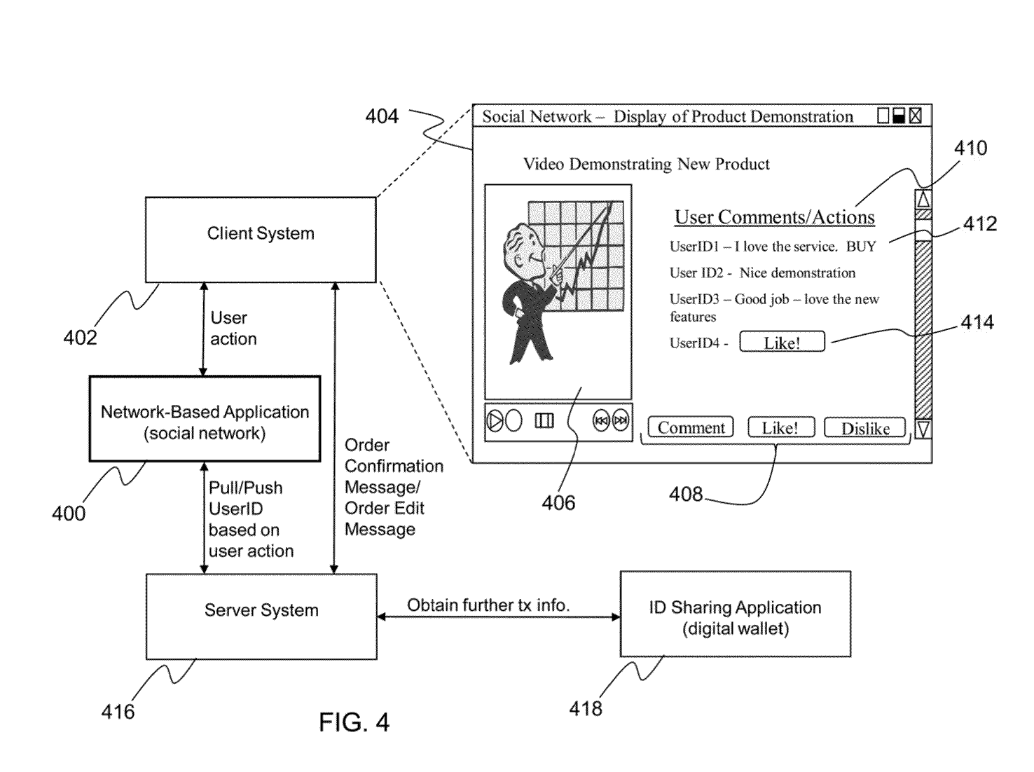

An illustration depicting the interaction of the present invention with other parts of a communications network is presented in FIG. 4. In particular, the invention is shown in the context of a social network 400 such as Facebook or MySpace.

When interacting with the social network 400, a user operates a client system 402, non-limiting examples of which include devices such as personal computers, mobile phones, and tablet-type computing devices. The client system 402 includes a display on which a client program such as a web-browser depicts a web page 404 displaying information from the seller of a product or service. The web page 404 includes information related to a product or service offered by the company. In this particular example, the information from the seller is in the form of a video 406 regarding a product or service, it will be appreciated by one of skill in the art that the information need not be limited to videos, but can be any form of multimedia information. The web page 404 includes a user action set 408, providing the user with a set of possible user actions that may be taken with respect to the product or service. As a non-limiting example of such a set 408, the web page 404 shown permits users to take actions, including “Comment”, “Like!”, and “Dislike”. As will be appreciated by one of skill in the art, user actions can take a wide variety of forms, including implicit actions such as those just listed or even explicit actions such as clicking a “Buy” button/link within a social network that may be embedded proximate information regarding the product or service or may be embedded within a text/blog stream, “on the fly” (such a button/link could be provided, for example, as part of a “like/comment/buy” set of possible actions in the text/blog stream. The above list is not intended to be exhaustive, but rather to provide a few examples of common user actions in the context of a social network in order to afford the reader with a general understanding of the term.

A list of historical user comments/actions 410 is shown, where users have taken actions of commenting and “Like!”ing. In order to facilitate a purchase through commenting, a particular text string is typed into a comment string. In this case, the term “BUY” was placed in the text string from the user of UserID1 412. To facilitate a purchase through “Like!”ing, the user of UserID4 selected the “Like!” button from the user action set 408, the result of which is depicted by element 414.

The server system 416 of the present invention monitors the activity on the social network 400 in order to detect user actions that trigger a sale. The information regarding user actions on the social network 400 may either be “pulled” from the social network 400 by the server system 416 or it may be “pushed” from the social network 400 to the server system 416 by software residing on the social network 400. The information received by the server system 416 includes, at minimum, the user identification of the user who took an action that triggered a sale (e.g., in this case UserID1 and UserID4). Non-limiting examples of other information that may be useful for the server system 416 may include additional text strings indicating aspects of the desired transaction such as quantity, color, style, size, etc. These can be facilitated by causing software to first detect a user action that triggers the sale and then searching for additional text strings that further define the desired transaction.

Once the server system 416 has obtained the user identification of a user who triggered a sale, the server system 416 queries an ID sharing application 418 (such as a digital wallet) to obtain additional transactional information. Non-limiting examples of additional transactional information that would be useful include payment (credit card) information, delivery address, billing address, phone contact information, etc, This information is used for completing the transaction.

During the transaction, typically, but not necessarily, before completing the financial part of the transaction, (payment), the server system 416 sends a message to the user confirming the validity of the transaction and requesting additional information, if needed. For example, the server system 416 may send an e-mail message to the user via the client system 402, requesting confirmation of the transaction and further requesting information such as quantity desired, delivery address, payment information, etc. The message need not he in e-mail form, and can be any form of communication with the user, non-limiting examples of which include phone calls, faxes, instant messages, or even messages sent back via the social network 400 such as comments.

It is important to note that the present invention need not be limited specifically to social networks, but is applicable to any type of network where users take actions akin to social actions, but where the network does not lend itself to direct e-commerce. As will be appreciated by those of skill in the art, non-limiting examples of current communications networks/applications to which the present invention is applicable include phone networks, sms (short, messaging services), mms (multimedia messaging services), e-mail systems, Pinterest (www.pinterest.com/). Twitter (www.twitter.com/), YouTube (www.youtube.com), Path (www.path.com), Instagram (www.instagram.com), and Carrier Pigeon (www.mycarrierpigeon.com).

1. A. method for placing an order for a product via a communications network, comprising acts of:
receiving information regarding a user action in a network-based application, where the user action is related to a product and includes a user ID;
correlating the user ID with further transactional information via an ID sharing application;
completing a transaction using the further transactional information; and
sending the user a message continuing the order of the product.

2. A method as set forth in claim 1, wherein the message sent to the user is selected from a group consisting of phone, fax, e-mail, and text messages.

3. A method as set forth in claim 1, wherein the message provides information that allows the user to alter order-related information.

4. A method as set forth in claim 3, wherein the order-related information is selected from a group consisting of canceling the order, altering a quantity of the product ordered, altering a payment method, and editing delivery information for the order.

5. A method as set forth in claim 1, where in the act of receiving information regarding a user action, the information is pushed from the network-based application to a second network-based application.

6. A method as set forth in claim 1, where in the act of receiving information regarding a user action, the information is pulled from the network-based application by a second network-based application.

7. A method as set forth in claim 1, where in the act of receiving information regarding a user action, the network-based application is a social network.

8. A method as set forth in claim 7, where the user action is a social action.

9. A method as set forth in claim 8, where the action is selected from a group consisting of rating, “liking,” and commenting.

10. A computer program product for placing an order for a product via a communications network, the computer program product containing computer-readable instructions for causing a data processing system to perform acts of:
receiving information regarding a user action in a network-based application, where the user action is related to a product and includes a user ID;
correlating the user ID with further transactional information via an ID sharing application;
completing a transaction using the further transactional information; and
sending the user a message confirming the order of the product.

11. A computer program product, as set forth in claim 10, wherein the message sent to the user is selected from a group consisting of phone, fax, e-mail, and text messages.

12. A computer program product as set forth in claim 10, wherein the message provides information that allows the user to alter order-related information.

13. A computer program product as set forth in claim 12, wherein the order-related information is selected from a group consisting of canceling the order, altering a quantity of the product ordered, altering a payment method, and editing delivery information for the order.

14. A computer program product as set forth in claim 10, where in the act of receiving information regarding a user action, the information is pushed from the network-based application to a second network-based application.

15. A computer program product as set forth in claim 10, where in the act of receiving information regarding a user action, the information is pulled from the network-based application by a second network-based application.

16. A computer program product as set forth in claim 10, where in the act of receiving information regarding a user action, the network-based application is a social network.

17. A computer program product as set forth in claim 16, where the user action is a social action.

18. A. computer program product as set forth in claim 17, where the action is selected from a group consisting of rating, “liking,” and commenting.

19. A system for placing an order for a product via a communications network, the communication network comprising a client system and a server system with computer-readable instructions thereon for causing acts of:
receiving information regarding a user action in a network-based application, where the user action is related to a product and includes a user ID;
correlating the user ID with further transactional information via an ID sharing application;
completing a transaction using the further transactional information; and
sending the user a message confirming the order of the product.

20. A system as set forth in claim 19, wherein the message sent to the user is selected from a group consisting of phone, fax, e-mail, and text messages.

21. A system as set forth in claim 19, wherein the message provides information that allows the user to alter order-related information.

22. A system as set forth in claim 21, wherein the order-related information is selected from a group consisting of canceling the order, altering a quantity of the product ordered, altering a payment method, and editing delivery information for the order.

23. A system as set forth in claim 19, where in the act of receiving information regarding a user action, the information is pushed from the network-based application to a second network-based application.

24. A system as set forth in claim 19, where in the act of receiving information regarding a user action, the information is pulled from the network-based application by a second network-based application.

25. A system as set forth in claim 19, where in the act of receiving information regarding a user action, the network-based application is a social network.

26. A system as set forth in claim 25, where the user action is a social action.

27. A system as set forth in claim 26, where the action is selected from a group consisting of rating, “liking,” and commenting.

28. A system for placing an order for a product via a communications network, comprising acts of:
under control of a client system:
in a first network-based application;
displaying information regarding the product;
in response to an user action in the first network-based system system;
in a second network-based application;
gathering information regarding the user action that provides a user ID; and
correlating the user identification with further transactional information via an ID sharing application;
completing the transaction using the further transactional information; and
sending the user a message confirming the order of the product.
